(19) United States
(12) Patent Application Publication
(10) Pub. No.: US 2024/0127570 A1
(43) Pub. Date: Apr. 18, 2024

(54) IMAGE ANALYSIS APPARATUS, IMAGE ANALYSIS METHOD, AND PROGRAM

(71) Applicant: FUJIFILM Corporation, Tokyo (JP)

(72) Inventors: Taro HATSUTANI, Tokyo (JP); Akimichi ICHINOSE, Tokyo (JP)

(73) Assignee: FUJIFILM Corporation, Tokyo (JP)

(21) Appl. No.: 18/481,198

(22) Filed: Oct. 4, 2023

(30) Foreign Application Priority Data
Oct. 17, 2022 (JP) 2022-165970

(51) Int. Cl. G06V 10/25; G06T 7/00; G06T 7/50; G06T 7/62

(52) U.S. Cl. CPC G06V 10/25; G06T 7/0012; G06T 7/50; G06T 7/62; G06T 2207/30096; G06V 2201/07

(57) ABSTRACT

An image analysis apparatus, an image analysis method, and a program for specifying a region of interest from an image in which an arrow is assigned to the region of interest are provided.

The above problem is solved by an image analysis apparatus including at least one processor, and at least one memory in which an instruction to be executed by the at least one processor is stored, in which the at least one processor is configured to receive an image in which an arrow is assigned to a region of interest, specify the arrow, dispose one or more region-of-interest candidates that are candidates of the region of interest in accordance with a direction of the arrow and with a distance from the arrow, calculate an interest degree for each region-of-interest candidate, and specify the region of interest from among the region-of-interest candidates based on the interest degree.

### CROSS-REFERENCE TO RELATED APPLICATION

The present application claims priority under 35 U.S.C § 119(a) to Japanese Patent Application No. 2022-165970 filed on Oct. 17, 2022, which is hereby expressly incorporated by reference, in its entirety, into the present application.

### BACKGROUND OF THE INVENTION

### 1. Field of the Invention

The present invention relates to an image analysis apparatus, an image analysis method, and a program, and particularly to a technology for using an image in which a region of interest is annotated with an arrow in training a learning model.

### 2. Description of the Related Art

In the case of specifying a region of interest from an image, it is general to use an object detection model or a segmentation model. These models are generated by learning a bounding box surrounding a target region of interest, or a mask that is an annotation for segmentation.

JP6689903B discloses a technology for extracting an arrow from an examination sheet and for specifying a machine zone closest to a head of the arrow using a region based convolutional neural networks (R-CNN) model.

### SUMMARY OF THE INVENTION

Learning the bounding box or the mask requires a large amount of correct answer data to which the bounding box or the mask is assigned. However, creating the correct answer data requires specifying a position of the region of interest in the image and assigning the bounding box or the mask, and this poses a problem of time consumption.

The present invention is conceived in view of such circumstances, and an object thereof is to provide an image analysis apparatus, an image analysis method, and a program for specifying a region of interest from an image in which an arrow is assigned to the region of interest.

In order to achieve the object, an image analysis apparatus according to a first aspect of the present disclosure is an image analysis apparatus comprising at least one processor, and at least one memory in which an instruction to be executed by the at least one processor is stored, in which the at least one processor is configured to receive an image in which an arrow is assigned to a region of interest, specify the arrow, dispose one or more region-of-interest candidates that are candidates of the region of interest in accordance with a direction of the arrow and with a distance from the arrow, calculate an interest degree for each region-of-interest candidate, and specify the region of interest from among the region-of-interest candidates based on the interest degree. According to the present aspect, since the region of interest can be specified from the image in which the arrow is assigned to the region of interest, correct answer data indicating the region of interest can be easily created. Accordingly, a learning model that estimates the region of interest from the image can be trained using the created correct answer data.

An image analysis apparatus according to a second aspect of the present disclosure is the image analysis apparatus according to the first aspect, in which it is preferable that the region-of-interest candidate has a shape with which a size and a position of the region of interest is specifiable.

An image analysis apparatus according to a third aspect of the present disclosure is the image analysis apparatus according to the second aspect, in which it is preferable that the region-of-interest candidate is a rectangle or a circle.

An image analysis apparatus according to a fourth aspect of the present disclosure is the image analysis apparatus according to any one of the first to third aspects, in which it is preferable that the at least one processor is configured to dispose the region-of-interest candidate in accordance with a first distance that is a first distance from a tip end of the arrow and that is in a normal direction of the direction of the arrow.

An image analysis apparatus according to a fifth aspect of the present disclosure is the image analysis apparatus according to any one of the first to fourth aspects, in which it is preferable that the at least one processor is configured to dispose the region-of-interest candidate in accordance with a second distance that is a second distance from a tip end of the arrow and that is in a direction parallel to the direction of the arrow.

An image analysis apparatus according to a sixth aspect of the present disclosure is the image analysis apparatus according to any one of the first to fifth aspects, in which it is preferable that the at least one processor is configured to acquire accessory information of the image, and dispose the region-of-interest candidate in accordance with the accessory information.

An image analysis apparatus according to a seventh aspect of the present disclosure is the image analysis apparatus according to the sixth aspect, in which it is preferable that the accessory information includes a sentence in which a content of the image is described.

An image analysis apparatus according to an eighth aspect of the present disclosure is the image analysis apparatus according to the sixth or seventh aspect, in which it is preferable that the image is a medical image, the region of interest is a lesion, and the accessory information includes information about a size of the lesion.

An image analysis apparatus according to a ninth aspect of the present disclosure is the image analysis apparatus according to any one of the first to eighth aspects, in which it is preferable that the at least one processor is configured to calculate the interest degree for each region-of-interest candidate using a first interest degree calculation model that outputs the interest degree of the input region-of-interest candidate in a case where a feature of the image and the region of interest are input, or a second interest degree calculation model that outputs the interest degree of the input region-of-interest candidate in a case where the image and the region-of-interest candidate are input.

An image analysis apparatus according to a tenth aspect of the present disclosure is the image analysis apparatus according to the ninth aspect, in which it is preferable that the first interest degree calculation model and the second interest degree calculation model are trained models that are trained by disposing a plurality of regions in an image having a known region of interest and by using an interest degree between the disposed region and the known region of interest as correct answer data.

An image analysis apparatus according to an eleventh aspect of the present disclosure is the image analysis apparatus according to any one of the first to tenth aspects, in which it is preferable that the at least one processor is configured to dispose a plurality of the region-of-interest candidates, and specify the region-of-interest candidate having a highest interest degree among the plurality of region-of-interest candidates as the region of interest.

In order to achieve the object, an image analysis method according to a twelfth aspect of the present disclosure is an image analysis method comprising receiving an image in which an arrow is assigned to a region of interest, specifying the arrow, disposing one or more region-of-interest candidates that are candidates of the region of interest in accordance with a direction of the arrow and with a distance from the arrow, calculating an interest degree for each region-of-interest candidate, and specifying the region of interest from among the region-of-interest candidates based on the interest degree. According to the present aspect, since the region of interest can be specified from the image in which the arrow is assigned to the region of interest, correct answer data indicating the region of interest can be easily created. Accordingly, a learning model that estimates the region of interest from the image can be trained using the created correct answer data.

In order to achieve the object, a program according to a thirteenth aspect of the present disclosure is a program causing a computer to execute the image analysis method according to the twelfth aspect. The present disclosure also includes a computer readable non-transitory recording medium such as a compact disk-read only memory (CD-ROM) in which the program according to the thirteenth aspect is stored.

According to the present invention, the region of interest can be specified from the image in which the arrow is assigned to the region of interest.

### BRIEF DESCRIPTION OF THE DRAWINGS

FIG. 1 is an overall configuration diagram of a medical image analysis system.

FIG. 2 is a block diagram illustrating an electric configuration of a medical image analysis apparatus.

FIG. 3 is a block diagram illustrating a functional configuration of the medical image analysis apparatus.

FIG. 4 is a flowchart illustrating a medical image analysis method according to a first embodiment.

FIG. 5 is a diagram illustrating processing of specifying a region of interest from a plurality of region-of-interest candidates.

FIG. 6 is a flowchart illustrating a medical image analysis method according to a second embodiment.

FIG. 7 is a flowchart illustrating a learning method of an interest degree calculation model.

FIG. 8 is a diagram illustrating a medical image used in training the interest degree calculation model.

FIG. 9 is a diagram illustrating an example of the interest degree calculation model.

FIG. 10 is a diagram illustrating another example of the interest degree calculation model.

FIG. 11 is a diagram illustrating an example of a relationship between an arrow and the region-of-interest candidate.

FIG. 12 is a diagram illustrating an example of the relationship between the arrow and the region-of-interest candidate.

FIG. 13 is a diagram illustrating an example of disposing each side of the region-of-interest candidate along a horizontal direction and a vertical direction of the image.

FIG. 14 is a diagram illustrating the medical image to which the arrow is assigned.

FIG. 15 is a diagram illustrating another example of the relationship between the arrow and the region-of-interest candidate.

### DESCRIPTION OF THE PREFERRED EMBODIMENTS

Hereinafter, preferred embodiments of the present invention will be described in detail with reference to the accompanying drawings. Here, a medical image analysis apparatus, a medical image analysis method, and a medical image analysis program will be illustratively described as examples of an image analysis apparatus, an image analysis method, and a program according to an embodiment of the present invention.

### Medical Image Analysis System

The medical image analysis system according to the present embodiment is a system that specifies a region of interest of a medical image from the medical image in which an arrow is assigned to a region of interest. The medical image in which the region of interest is specified can be used as correct answer data for training a learning model that estimates the region of interest from the medical image.

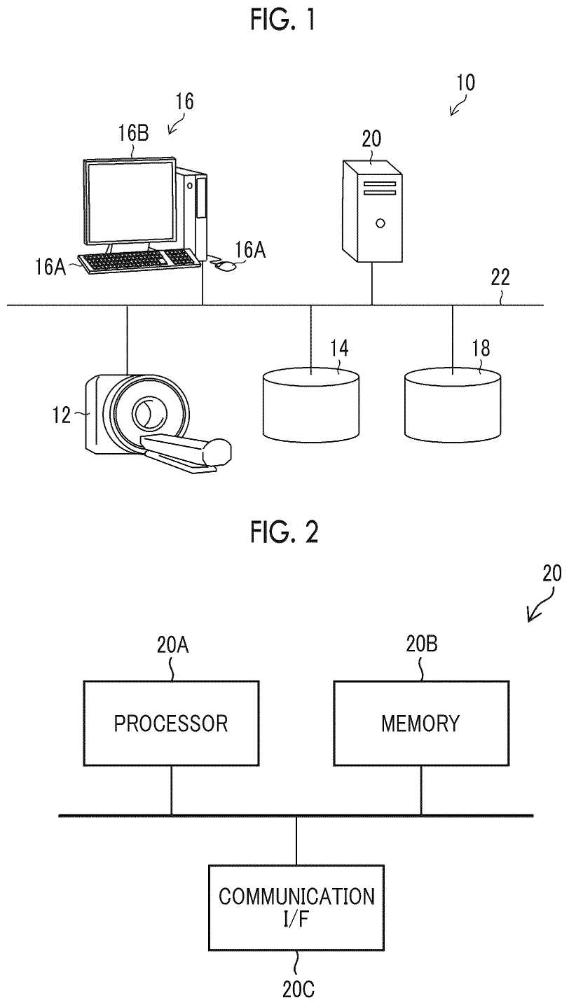

FIG. 1 is an overall configuration diagram of a medical image analysis system 10. As illustrated in FIG. 1, the medical image analysis system 10 is configured to comprise a medical image examination apparatus 12, a medical image database 14, a user terminal apparatus 16, a reading report database 18, and a medical image analysis apparatus 20.

The medical image examination apparatus 12, the medical image database 14, the user terminal apparatus 16, the reading report database 18, and the medical image analysis apparatus 20 are connected to each other through a network 22 to be capable of transmitting and receiving data. The network 22 includes a wired or wireless local area network (LAN) that connects various apparatuses to communicate with each other in a medical institution. The network 22 may include a wide area network (WAN) that connects a plurality of medical institutions to each other.

The medical image examination apparatus 12 is an imaging apparatus that images an examination target part of a subject to generate a medical image. Examples of the medical image examination apparatus 12 include an X-ray imaging apparatus, a computed tomography (CT) apparatus, a magnetic resonance imaging (MRI) apparatus, a positron emission tomography (PET) apparatus, an ultrasound apparatus, a computed radiography (CR) apparatus using a planar X-ray detector, and an endoscope apparatus.

The medical image database 14 is a database that manages the medical image captured by the medical image examination apparatus 12. A computer comprising a high-capacity storage device for storing the medical image is applied as the medical image database 14. The computer incorporates software that provides the function of the database management system.

The medical image may be a two-dimensional still image or a three-dimensional still image captured by an X-ray imaging apparatus, a CT apparatus, an MRI apparatus, or the like or may be a video captured by an endoscope apparatus.

A digital imaging and communications in medicine (Dicom) standard can be applied as a format of the medical image. Accessory information (Dicom tag information) defined in the Dicom standard may be added to the medical image. The term “image” in the present specification includes not only a meaning of the image itself such as a photo but also a meaning of image data that is a signal representing the image.

The user terminal apparatus 16 is a terminal apparatus with which a doctor creates and views a reading report. For example, a personal computer is applied as the user terminal apparatus 16. The user terminal apparatus 16 may be a workstation or may be a tablet terminal. The user terminal apparatus 16 comprises an input device 16A and a display 16B. The doctor inputs an instruction to display the medical image using the input device 16A. The user terminal apparatus 16 displays the medical image on the display 16B. Furthermore, the doctor reads the medical image displayed on the display 16B and creates the reading report by assigning an arrow to a lesion that is the region of interest of the medical image using the input device 16A and by inputting a medical opinion that is a reading result.

The arrow is a symbol used to indicate a direction. For example, “i” that is an upward arrow is disposed below the region of interest of the medical image and indicates that the region of interest is present above the arrow. A direction, a shape, a thickness, and a color of the arrow assigned to the region of interest are not limited as long as the region of interest is indicated.

In a case where the arrow is assigned in the medical image, the user terminal apparatus 16 may write the arrow on the medical image or may superimpose the arrow on a different layer from the medical image.

The reading report database 18 is a database that manages the reading report generated by the doctor in the user terminal apparatus 16. The reading report includes the medical image to which the arrow is assigned. A computer comprising a high-capacity storage device for storing the reading report is applied as the reading report database 18. The computer incorporates software that provides the function of the database management system. The medical image database 14 and the reading report database 18 may be composed of one computer.

The medical image analysis apparatus 20 is an apparatus that specifies the region of interest of the medical image. A personal computer or a workstation (an example of a “computer”) can be applied as the medical image analysis apparatus 20. FIG. 2 is a block diagram illustrating an electric configuration of the medical image analysis apparatus 20. As illustrated in FIG. 2, the medical image analysis apparatus 20 comprises a processor 20A, a memory 20B, and a communication interface 20C.

The processor 20A executes an instruction stored in the memory 20B. A hardware structure of the processor 20A includes the following various processors. The various processors include a central processing unit (CPU) that is a general-purpose processor acting as various functional units by executing software (program), a graphics processing unit (GPU) that is a processor specialized in image processing, a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute specific processing, and the like.

One processing unit may be composed of one of the various processors or may be composed of two or more processors of the same type or different types (for example, a plurality of FPGAs, a combination of a CPU and an FPGA, or a combination of a CPU and a GPU). In addition, a plurality of functional units may be composed of one processor. A first example of the plurality of functional units composed of one processor is, as represented by a computer such as a client or a server, a form of one processor composed of a combination of one or more CPUs and software, in which the processor acts as the plurality of functional units. A second example is, as represented by a system on chip (SoC) or the like, a form of using a processor that implements functions of the entire system including the plurality of functional units in one integrated circuit (IC) chip. In such a manner, various functional units are configured using one or more of the various processors as a hardware structure.

Furthermore, the hardware structure of the various processors is, more specifically, an electric circuit (circuitry) in which circuit elements such as semiconductor elements are combined.

The memory 20B stores an instruction to be executed by the processor 20A. The memory 20B includes a random access memory (RAM) and a read only memory (ROM), not illustrated. The processor 20A executes software in the RAM as a work region using various programs including the medical image analysis program, described later, and a parameter stored in the ROM and executes various types of processing of the medical image analysis apparatus 20 using the parameter stored in the ROM or the like.

The communication interface 20C controls communication with the medical image examination apparatus 12, the medical image database 14, the user terminal apparatus 16, and the reading report database 18 through the network 22 in accordance with a predetermined protocol.

The medical image analysis apparatus 20 may be a cloud server that can be accessed from a plurality of medical institutions through the Internet. Processing performed in the medical image analysis apparatus 20 may be a paid or fixed-rate cloud service.

### Functional Configuration as Medical Image Analysis Apparatus

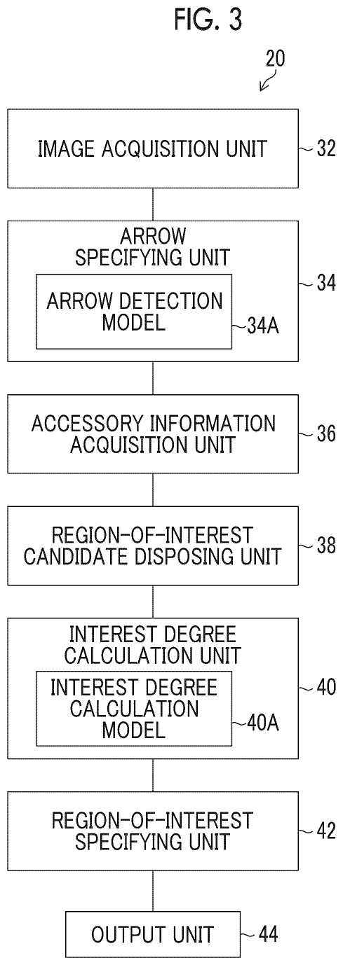

FIG. 3 is a block diagram illustrating a functional configuration of the medical image analysis apparatus 20. Each function of the medical image analysis apparatus 20 is realized by executing the medical image analysis program stored in the memory 20B via the processor 20A. As illustrated in FIG. 3, the medical image analysis apparatus 20 comprises an image acquisition unit 32, an arrow specifying unit 34, an accessory information acquisition unit 36, a region-of-interest candidate disposing unit 38, an interest degree calculation unit 40, a region-of-interest specifying unit 42, and an output unit 44.

The image acquisition unit 32 acquires the medical image in which the arrow is assigned to the lesion, which is the region of interest, from the reading report database 18. The arrow may be written on the medical image or may be superimposed on a different layer from the medical image.

The arrow specifying unit 34 specifies the arrow included in the medical image received by the image acquisition unit 32. Specifying the arrow includes specifying a position and a direction of the arrow. The arrow specifying unit 34 includes an arrow detection model 34A. The arrow detection model 34A is a known object detection model or extraction model to which a convolutional neural network (CNN) is applied. The arrow detection model 34A is stored in the memory 20B.

The accessory information acquisition unit 36 acquires accessory information as an accessory to the medical image acquired by the image acquisition unit 32. The accessory information may include a sentence in which a content of the medical image is described. The accessory information includes information about the region of interest. The information about the region of interest may include information about a size of the region of interest, may include information about a shape of the region of interest, or may include information about a position of the region of interest. The information about the shape may include information about an aspect ratio.

The accessory information acquisition unit 36 may acquire the reading report of the medical image as the accessory information of the medical image acquired by the image acquisition unit 32 and acquire the information about the region of interest from the medical opinion of the reading report.

The region-of-interest candidate disposing unit 38 disposes one or more region-of-interest candidates that are candidates of the region of interest of the medical image on the medical image. The region-of-interest candidate disposing unit 38 may dispose the region-of-interest candidate in accordance with the direction of the arrow and a distance from the arrow specified by the arrow specifying unit 34. The region-of-interest candidate has a shape with which an approximate size and an approximate position of the region of interest can be specified. For example, the region-of-interest candidate is a rectangle of a circle. The rectangle is a quadrangle having a right angle at every corner and is an oblong or a square. In addition, the circle is not limited to a perfect circle and includes an ellipse.

The region-of-interest candidate disposing unit 38 may dispose the region-of-interest candidate in accordance with the accessory information acquired by the accessory information acquisition unit 36. The region-of-interest candidate disposing unit 38 may dispose the region-of-interest candidate in accordance with at least one of the information about the size, the information about the shape, or the information about the position of the region of interest acquired by the accessory information acquisition unit 36.

The interest degree calculation unit 40 calculates an interest degree for each region-of-interest candidate disposed by the region-of-interest candidate disposing unit 38. The interest degree may be an indicator representing likelihood that the region-of-interest candidate is a correct answer region of interest, or may be an indicator of which a value is relatively increased as the likelihood is relatively increased.

The interest degree calculation unit 40 includes an interest degree calculation model 40A. The interest degree calculation model 40A is a learning model (an example of a “first interest degree calculation model”) that outputs the interest degree of the input region-of-interest candidate in a case where an image feature (an example of a “feature of the image”) and the region-of-interest candidate are input, or a learning model (an example of a “second interest degree calculation model”) that outputs the interest degree of the input region-of-interest candidate in a case where the image and the region-of-interest candidate are input. The interest degree calculation model 40A is a trained model that is trained by disposing a plurality of regions in the image having a known region of interest and by using the interest degree between the disposed region and the known region of interest as the correct answer data. The interest degree calculation model 40A may be a trained model to which a CNN is applied. The interest degree calculation model 40A is stored in the memory 20B.

The image feature is a feature on the image that can be visually recognized by human vision. The image feature is, for example, a region having relatively high brightness, a region having relatively low brightness, or an edge region having rapidly changing brightness.

The region-of-interest specifying unit 42 specifies any of the region-of-interest candidates as the region of interest based on the interest degree calculated by the interest degree calculation unit 40. The region-of-interest specifying unit 42 may specify the region-of-interest candidate of which the calculated interest degree is the highest, that is, of which the likelihood of being the region of interest is the highest, as the region of interest.

The output unit 44 outputs the region of interest specified by the region-of-interest specifying unit 42 and records the region of interest in a database for learning, not illustrated, in association with the medical image. The output unit 44 may assign a bounding box or a mask to the position of the region of interest in the medical image and output the region of interest. The medical image in which the bounding box or the mask is assigned to the position of the region of interest can be used as the correct answer data in training the learning model that estimates the region of interest from the medical image.

### Medical Image Analysis Method: First Embodiment

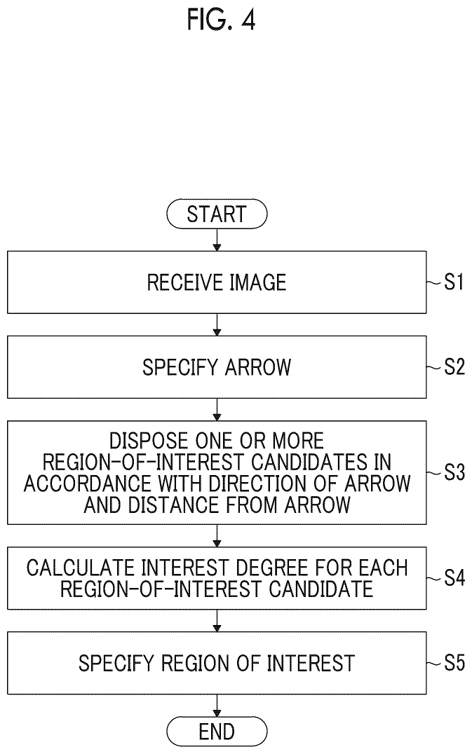

FIG. 4 is a flowchart illustrating the medical image analysis method according to a first embodiment using the medical image analysis apparatus 20. The medical image analysis method is a method of specifying the region of interest of the medical image to which the arrow is assigned. The medical image analysis method is implemented by executing the medical image analysis program stored in the memory 20B via the processor 20A. The medical image analysis program may be provided by a computer readable non-transitory storage medium or may be provided through the Internet.

In step S1, the image acquisition unit 32 receives the medical image to which the arrow is assigned from the reading report database 18. The image acquisition unit 32 may receive the medical image to which the arrow is assigned from an apparatus other than the reading report database 18 through the network 22.

In step S2, the arrow specifying unit 34 specifies the arrow of the medical image received in step S1 using the arrow detection model 34A.

In step S3, the region-of-interest candidate disposing unit 38 disposes one or more region-of-interest candidates that are candidates of the region of interest of the medical image received in step S1 in accordance with the direction of the arrow and the distance from the arrow specified in step S2.

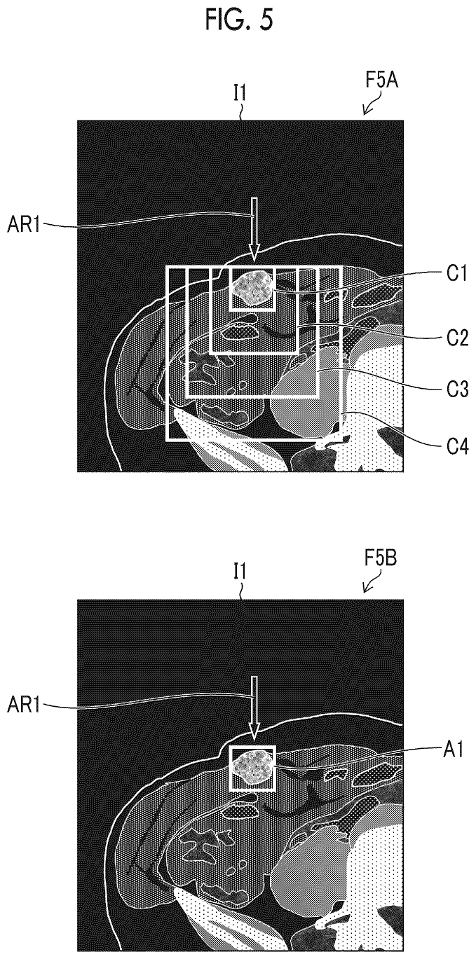

FIG. 5 is a diagram illustrating processing of specifying the region of interest from a plurality of region-of-interest candidates. F5A in FIG. 5 shows a medical image I1 that is a medical image I1 to which an arrow AR1 is assigned and in which a plurality of region-of-interest candidates are disposed with respect to the arrow AR1. In F5A, four region-of-interest candidates C1, C2, C3, and C4 that are square regions having different sizes are disposed. Each of the region-of-interest candidates C1, C2, C3, and C4 is disposed such that a side closest to a tip end of the arrow is on a straight line that is a straight line passing through a position separated from the tip end of the arrow by a constant distance in a direction parallel to the direction of the arrow and that is parallel to a direction (an example of a “normal direction of the direction of the arrow”) orthogonal to the direction of the arrow.

In addition, each of the region-of-interest candidates C1, C2, C3, and C4 is disposed such that an intersection between the side closest to the tip end of the arrow and a line extending from the arrow is at a position of a middle point of the side closest to the tip end of the arrow. That is, each of the region-of-interest candidates C1, C2, C3, and C4 is disposed at a position at which each of the region-of-interest candidates C1, C2, C3, and C4 is equally divided by the line extending from the arrow.

A distance between the tip end of the arrow assigned to the medical image and the region of interest of the medical image changes depending on a target of the region of interest. For example, in a case where the region of interest is a tumor, the arrow is assigned to a position relatively far from the region of interest because the doctor is also interested in an edge part of the tumor. That is, the distance between the tip end of the arrow and the region of interest is relatively long. On the other hand, in a case where the region of interest is a boundary of an organ or the like, the arrow is assigned to a position relatively close to the region of interest. That is, the distance between the tip end of the arrow and the region of interest is relatively short.

Accordingly, it is preferable to determine distances between the region-of-interest candidates C1, C2, C3, and C4 and the tip end of the arrow in accordance with the target of the region of interest.

In step S4, the interest degree calculation unit 40 calculates the interest degree for each region-of-interest candidate disposed in step S3. In the example illustrated in FIG. 5, the interest degree calculation unit 40 acquires the interest degree of each of the region-of-interest candidates C1, C2, C3, and C4 by inputting the image feature of the medical image I1 and the region-of-interest candidates C1, C2, C3, and C4 into the interest degree calculation model 40A.

In step S5, the region-of-interest specifying unit 42 specifies the region of interest based on the interest degree calculated in step S4. For example, the region-of-interest candidate having the highest interest degree among the region-of-interest candidates C1, C2, C3, and C4 is specified as the region of interest. F5B in FIG. 5 shows the medical image I1 in which a region of interest A1 is specified with respect to the arrow AR1. In FSB, the region-of-interest candidate C1 shown in F5A is specified as the region of interest A1.

Furthermore, the output unit 44 records the region of interest A1 in the database for learning in association with the medical image I1. The output unit 44 may output the medical image I1 to which a square indicating the region-of-interest candidate C1 specified as the region of interest A1 is assigned. Accordingly, the medical image I1 can be used as the correct answer data of the learning model that estimates the region of interest from the image.

### Medical Image Analysis Method: Second Embodiment

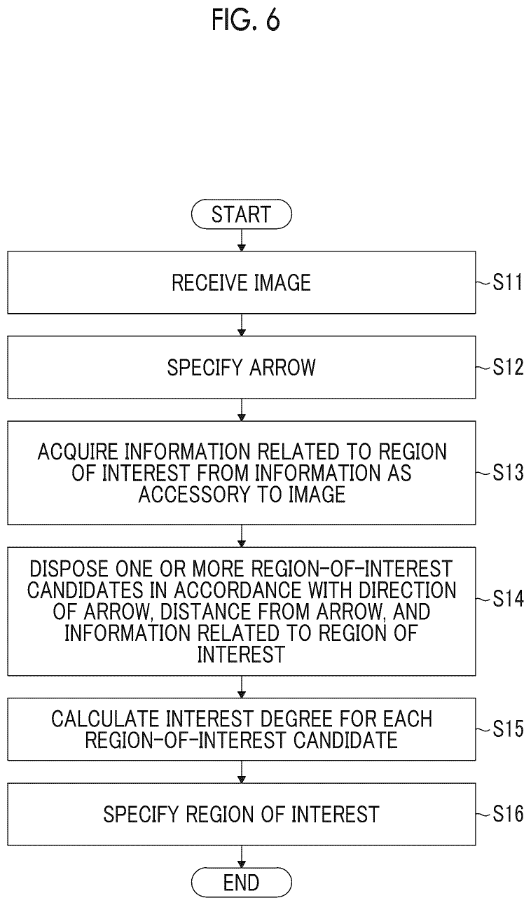

FIG. 6 is a flowchart illustrating a medical image analysis method according to a second embodiment.

In step 511, the image acquisition unit 32 receives the medical image to which the arrow is assigned from the reading report database 18. In addition, the accessory information acquisition unit 36 receives the reading report related to the medical image as the accessory information of the medical image received by the image acquisition unit 32.

In step S12, the arrow specifying unit 34 specifies the arrow of the medical image received in step S11 using the arrow detection model 34A.

In step S13, the accessory information acquisition unit 36 acquires information about the lesion from the medical opinion of the reading report received in step S11. The information about the lesion includes at least one of information about a size, a shape, or a position of the lesion. The information about the size of the lesion is, for example, “nodule of 8 mm”.

In step S14, the region-of-interest candidate disposing unit 38 disposes one or more region-of-interest candidates in accordance with the direction of the arrow and the distance from the arrow specified in step S12 and with the information about the lesion acquired in step S13. For example, it is assumed that “8 mm” that is the information about the size of the lesion is converted into a size on the image, and a size of the region-of-interest candidate is set to the size of the lesion on the image. In such a manner, by using the information about the size of the lesion, the region-of-interest candidate having a size corresponding to the size of the lesion can be disposed. Similarly, by using the information about the shape of the lesion, the region-of-interest candidate having a shape corresponding to the shape of the lesion can be disposed. By using the information about the position of the lesion, the region-of-interest candidate can be disposed at a position corresponding to the position of the lesion.

Steps S15 and S16 are the same as steps S4 and S5 of the first embodiment.

In such a manner, by disposing the region-of-interest candidate in accordance with information related to the region of interest in addition to the direction of the arrow and the distance from the arrow, the region-of-interest candidate can be appropriately disposed. Thus, the region of interest can be appropriately specified.

### Interest Degree Calculation Model: Third Embodiment

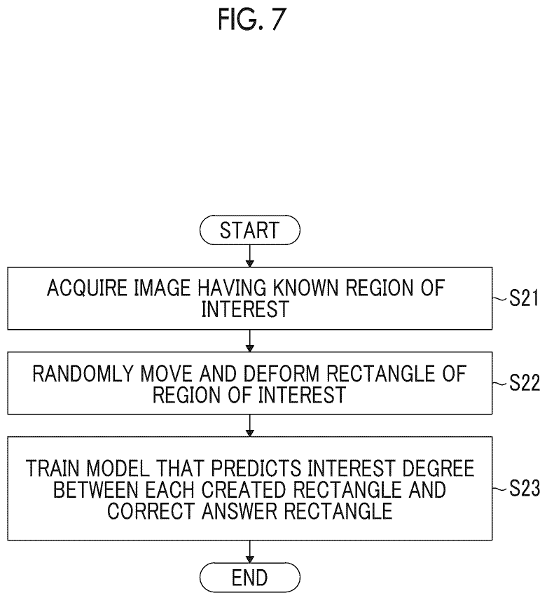

FIG. 7 is a flowchart illustrating a learning method of the interest degree calculation model 40A. Here, an example of training the interest degree calculation model 40A in the medical image analysis apparatus 20 will be described. The interest degree calculation model 40A may be trained in a computer different from the medical image analysis system 10.

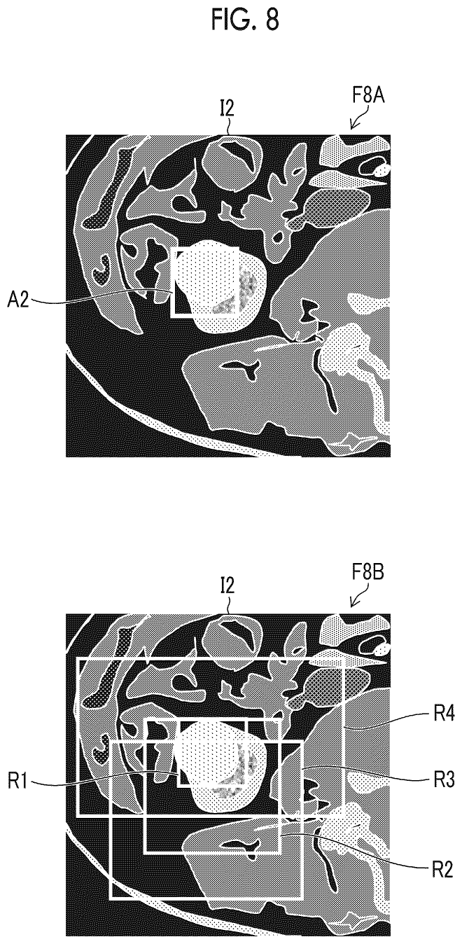

In step S21, the processor 20A acquires the medical image having a known region of interest. FIG. 8 is a diagram illustrating the medical image used in training the interest degree calculation model 40A. F8A in FIG. 8 shows a medical image I2 having a known region of interest A2. Here, it is assumed that the processor 20A acquires the medical image I2.

In step S22, the processor 20A creates a rectangle obtained by randomly moving and deforming the rectangle of the region of interest in the medical image I2. F8B in FIG. 8 shows rectangles R1, R2, R3, and R4 that are four rectangles (an example of a “plurality of regions”) each being obtained by moving and deforming the rectangle of the region of interest A2 in the medical image I2. While four rectangles are created here, the number of rectangles is not limited.

In step S23, the processor 20A trains a model that predicts the interest degree between each of the rectangles R1, R2, R3, and R4 created in step S22 and the region of interest A2 which is a correct answer rectangle. That is, the processor 20A creates the interest degree calculation model 40A by training the model using information about the medical image I2 and each of the rectangles R1, R2, R3, and R4 as input and using the interest degree between a region of each of the rectangles R1, R2, R3, and R4 and the region of interest A2 as the correct answer data of each of the rectangles R1, R2, R3, and R4. It is assumed that the interest degree is a value related to a degree of overlapping between the correct answer rectangle and the moved and deformed rectangle. The interest degree may be, for example, intersection over union (IoU). Instead of learning a value of IoU itself as the correct answer data of the interest degree, a value (target value) obtained by converting the value of IoU using a function may be used as the correct answer data.

The function of converting the value of IoU may be a square root, a hyperbolic tangent function (tanh function), or a step function corresponding to a threshold value. In the case of the tanh function, target value=(tanh (iou×5−2)+1)/2 may be established in a case where the value of IoU is denoted by iou.

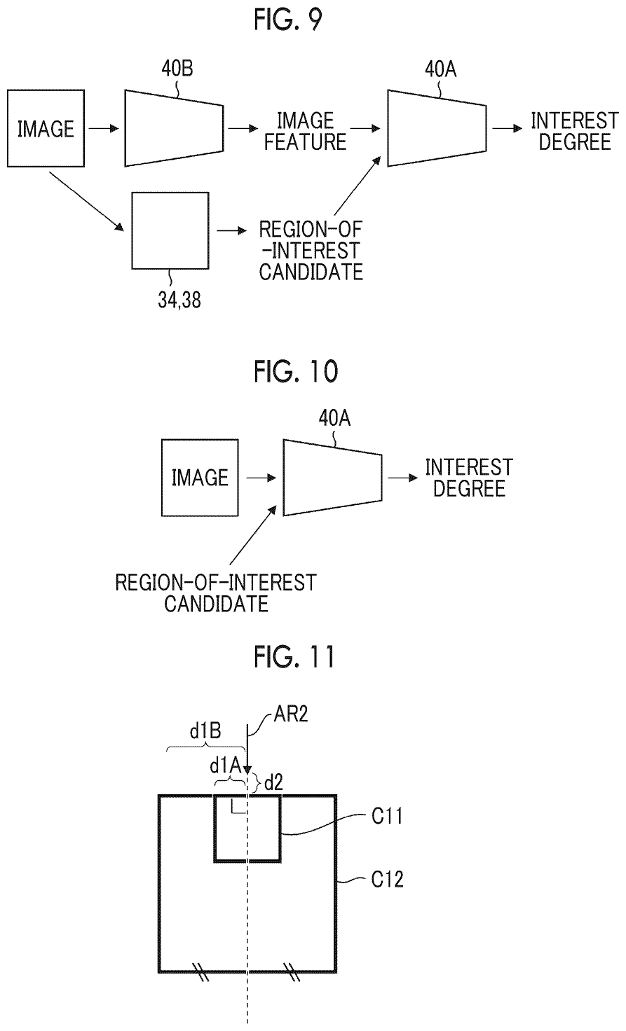

FIG. 9 is a diagram illustrating an example of the interest degree calculation model 40A trained in such a manner. The interest degree calculation model 40A illustrated in FIG. 9 outputs the interest degree of the input region-of-interest candidate in a case where the image feature and the region-of-interest candidate are input. In the example illustrated in FIG. 9, the region-of-interest candidate disposed by the region-of-interest candidate disposing unit 38 is input into the interest degree calculation model 40A. In addition, the image feature input into the interest degree calculation model 40A is input from an image feature extraction model 40B. The image feature extraction model 40B is a learning model that outputs the image feature of the input image in a case where the image is input. The image feature extraction model 40B is stored in the memory 20B.

FIG. 10 is a diagram illustrating another example of the interest degree calculation model 40A. The interest degree calculation model 40A illustrated in FIG. 10 outputs the interest degree of the input region-of-interest candidate in a case where the image and the region-of-interest candidate are input. The image itself is input into the interest degree calculation model 40A. In addition, in the same manner as the example illustrated in FIG. 9, the region-of-interest candidate disposed by the region-of-interest candidate disposing unit 38 is input into the interest degree calculation model 40A.

The interest degree calculation unit 40 may comprise the interest degree calculation model 40A illustrated in FIG. 9 and the interest degree calculation model 40A illustrated in FIG. 10. In this case, the interest degree calculation unit 40 may combine results of both as a final interest degree. By using the interest degree calculation model 40A, the interest degree calculation unit 40 can appropriately calculate the interest degree of the region-of-interest candidate.

### Method of Disposing region-of-interest candidate: Fourth Embodiment

FIG. 11 is a diagram illustrating an example of a relationship between the arrow specified by the arrow specifying unit 34 and the region-of-interest candidate disposed by the region-of-interest candidate disposing unit 38. Here, region-of-interest candidates C11 and C12 that are square regions, that is, regions having a width-to-height ratio of 1:1, having different sizes are disposed with respect to an arrow AR2. Each of the region-of-interest candidates C11 and C12 is disposed such that a side closest to a tip end of the arrow is on a straight line that is a straight line passing through a position separated from the tip end of the arrow by a distance d2 (an example of a “second distance”) in a direction parallel to the direction of the arrow and that is parallel to a direction orthogonal to the direction of the arrow. In addition, each of the region-of-interest candidates C11 and C12 is disposed such that an intersection between the side closest to the tip end of the arrow and a line extending from the arrow is at a position of a middle point of the side closest to the tip end of the arrow. That is, each of the region-of-interest candidates C11 and C12 is disposed at a position at which each of the region-of-interest candidates C11 and C12 is equally divided by the line extending from the arrow. The region-of-interest candidates C11 and C12 are disposed in accordance with a distance (an example of a “first distance”) that is a distance from the arrow and that is in a direction orthogonal to the direction of the arrow. In the example illustrated in FIG. 11, the distance of the region-of-interest candidate C11 from the arrow is d1A, and the distance of the region-of-interest candidate C12 from the arrow is d1B.

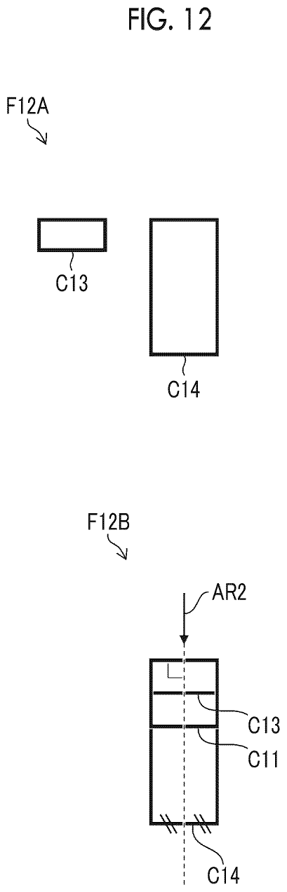

FIG. 12 is a diagram illustrating an example of the relationship between the arrow specified by the arrow specifying unit 34 and the region-of-interest candidate disposed by the region-of-interest candidate disposing unit 38.

F12A in FIG. 12 shows a region-of-interest candidate C13 that is a region of a rectangle having a width-to-height ratio of 1:2, and a region-of-interest candidate C14 that is a region of a rectangle having a width-to-height ratio of 1:0.5.

The region-of-interest candidate disposing unit 38 disposes the region-of-interest candidates C13 and C14 in addition to the region-of-interest candidates C11 and C12 disposed with respect to the arrow AR2. F12B in FIG. 12 shows the region-of-interest candidates C13 and C14 disposed with respect to the arrow AR2. In F12B, the region-of-interest candidate C12 is not illustrated. In the same manner as the region-of-interest candidate C11, the region-of-interest candidates C13 and C14 are disposed to overlap with each other at positions at which the side of each of the region-of-interest candidates C13 and C14 closest to the tip end of the arrow is separated from the tip end of the arrow by a constant distance in the direction parallel to the direction of the arrow. In addition, each of the region-of-interest candidates C13 and C14 is disposed at a position at which each of the region-of-interest candidates C13 and C14 is equally divided by the line extending from the arrow. The region-of-interest candidates C13 and C14 are disposed in accordance with a distance (an example of the “second distance”) that is a distance from the arrow and that is in a direction parallel to the direction of the arrow.

In such a manner, by disposing the region-of-interest candidate having various sizes and shapes in accordance with the distance from the arrow, the region of interest can be appropriately specified.

Up to this point, each side of the rectangle of the region-of-interest candidate has been disposed along the direction orthogonal to the direction of the arrow and along the direction parallel to the direction of the arrow. However, the direction of the rectangle of the region-of-interest candidate is not limited thereto. The region-of-interest candidate disposing unit 38 may dispose each side of the region-of-interest candidate along a horizontal direction and a vertical direction of the image or may dispose each side of the region-of-interest candidate along a horizontal direction and a vertical direction of a screen of a display on which the image is displayed.

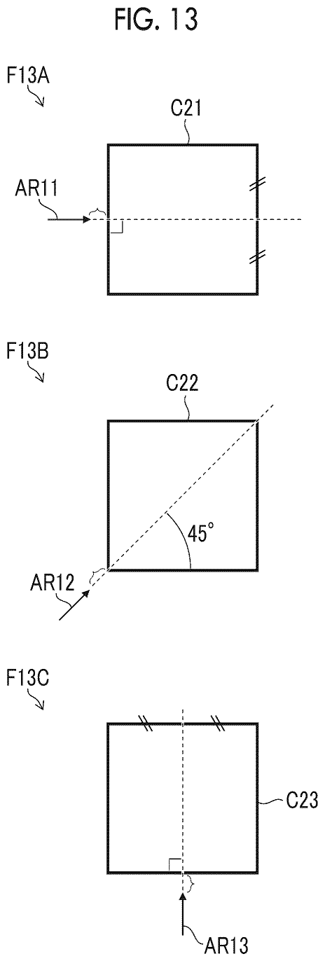

FIG. 13 is a diagram illustrating another example of the relationship between the arrow specified by the arrow specifying unit 34 and the region-of-interest candidate disposed by the region-of-interest candidate disposing unit 38. Here, an example of disposing each side of the region-of-interest candidate along the horizontal direction and the vertical direction of the image will be described. F13A in FIG. 13 shows a case where an arrow AR11 in the horizontal direction is assigned. A region-of-interest candidate C21 disposed with respect to the arrow AR11 is disposed such that a side closest to a tip end of the arrow AR11 is on a straight line that is a straight line passing through a position separated from the tip end of the arrow AR11 by a constant distance in the horizontal direction of the image and that is parallel to the vertical direction of the image. In addition, the region-of-interest candidate C21 is disposed at a position at which the region-of-interest candidate C21 is equally divided by the line extending from the arrow AR11.

F13B in FIG. 13 shows a case where an arrow AR12 having an angle of 45 degrees with respect to the horizontal direction and to the vertical direction is assigned. The region-of-interest candidate C22 disposed with respect to the arrow AR12 is disposed at a position that is a position at which a tip end of the arrow AR12 and a corner closest to the arrow AR12 are separated by a constant distance and at which a line extending from the arrow AR12 intersects with the corner closest to the arrow AR12. In addition, the region-of-interest candidate C22 is disposed at a position at which the region-of-interest candidate C22 is equally divided by the line extending from the arrow AR12.

F13C in FIG. 13 shows a case where an arrow AR13 in the vertical direction is assigned. A region-of-interest candidate C23 disposed with respect to the arrow AR13 is disposed such that a side closest to a tip end of the arrow AR13 is on a straight line that is a straight line passing through a position separated from the tip end of the arrow AR13 by a constant distance in the vertical direction of the image and that is parallel to the horizontal direction of the image. In addition, the region-of-interest candidate C23 is disposed at a position at which the region-of-interest candidate C23 is equally divided by the line extending from the arrow AR13.

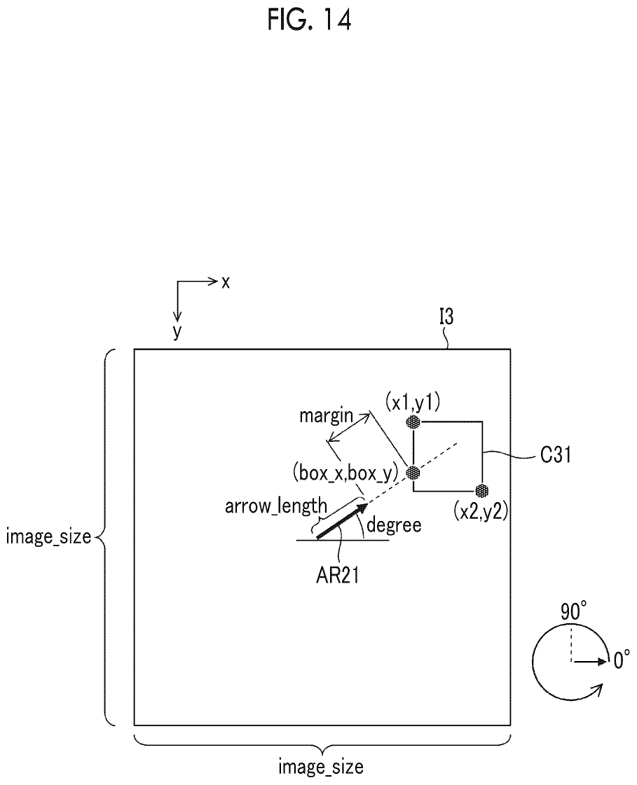

FIG. 14 is a diagram illustrating a medical image I3 to which an arrow AR21 is assigned. Here, a case where a region-of-interest candidate C31 that is a region of a rectangle is disposed on the medical image I3 will be described. Here, each side of the region-of-interest candidate C31 is disposed along the horizontal direction and the vertical direction of the medical image I3.

A two-dimensional xy coordinate system in which a rightward direction of the horizontal direction is an x direction and a downward direction of the vertical direction is a y direction using an upper left corner of the medical image I3 as an origin is set. An angle in the two-dimensional xy coordinate system is defined as being positive in a counterclockwise direction by setting the rightward direction of the horizontal direction as 0 degrees.

A size of the medical image I3 in each of the x direction and the y direction is denoted by image_size. In addition, a length of the arrow AR21 is denoted by arrow_length, an angle of the arrow AR21 is denoted by degree, and a distance between a tip end of the arrow AR21 and the region-of-interest candidate C31 is denoted by margin. In a case where it is assumed that a start point of the arrow AR21 is a center of the medical image I3, an x coordinate arrow_x and a y coordinate arrow_y of the tip end of the arrow AR21 are represented as follows.

arrow_x=cos_theta * arrow_length+image_size/2

arrow_y=sin_theta * arrow_lengt +image_size/2

Here,

cos theta=cos (degree/180 * π)

sin_theta=−sin (degree/180 * π)

are established. That is, the arrow AR21 is an arrow toward (arrow_x, arrow_y) from the center (image_size/2, image_size/2) of the medical image I3.

In addition, an x coordinate box_x and a y coordinate box_y of an intersection between an extension line of the arrow AR21 and the side of the region-of-interest candidate C31 are represented as follows.

box_x=cos_theta * (arrow_length+margin)+image_size/2

box_y=sin_theta * (arrow_length+margin)+image_size/2

In the example illustrated in FIG. 14, 0≥degree <45 is established. Thus, in a case where start_ratio=(degree+45)/90 is established, a size of the region-of-interest candidate C31 in the x direction is denoted by size_x, and a size of the region-of-interest candidate C31 in the y direction is denoted by size_y, coordinates (x1, y1) of the upper left and coordinates (x2, y2) of the lower right of the region-of-interest candidate C31 are represented as follows.

(x1 , y1) =(box_x, box_y−size_y * start_ratio)

(x2, y2) =(box_ +size_x, y1+size_y)

In such a manner, the region-of-interest candidate having sides along the horizontal direction and the vertical direction of the image can be disposed regardless of the angle degree of the arrow AR21.

While one region-of-interest candidate is disposed in the example illustrated in FIG. 14, region-of-interest candidates having various sizes and shapes may be disposed in accordance with the distance from the arrow using the above rules.

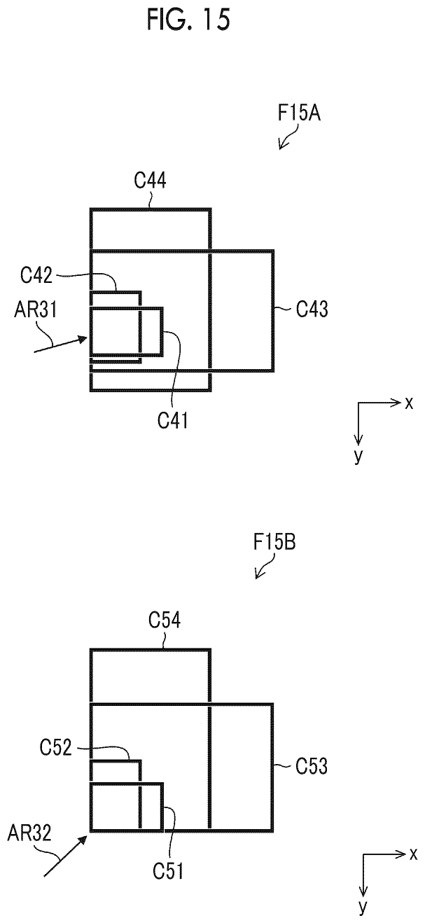

FIG. 15 is a diagram illustrating an example of disposing the region-of-interest candidates that are region-of-interest candidates having sides along the horizontal direction and the vertical direction of the image and that have various sizes and shapes.

F15A in FIG. 15 shows region-of-interest candidates C41, C42, C43, and C44 disposed with respect to an arrow AR31 that is an arrow AR31 disposed on the medical image and that is approximately 15° above the horizontal direction of the medical image in an upper right direction. In addition, F15B in FIG. 15 shows region-of-interest candidates C51, C52, C53, and C54 disposed with respect to an arrow AR32 that is an arrow AR32 disposed on the medical image and that is approximately 45° above the horizontal direction of the medical image in the upper right direction.

As illustrated in FIG. 15, in the rectangles of the region-of-interest candidates C41, C42, C43, C44, C51, C52, C53, and C54, each side is disposed along the horizontal direction (x direction in FIG. 15) and the vertical direction (y direction in FIG. 15) of the medical image regardless of the direction of the arrow. In the example illustrated in F15A, sides of the region-of-interest candidates C41, C42, C43, and C44 are disposed near a tip end of the arrow AR31. In addition, in the example illustrated in F15B, corners of the region-of-interest candidates C51, C52, C53, and C54 are disposed near a tip end of the arrow AR32.

Even in a case where the region-of-interest candidates are disposed in such a manner, the region of interest can be appropriately specified because the region-of-interest candidates are disposed in accordance with the direction of the arrow and with the distance from the arrow.

As described above, according to the medical image analysis method according to the embodiment of the present disclosure, the arrow of the image to which the arrow is assigned is specified, and one or more region-of-interest candidates that are candidates of the region of interest of the image are disposed in accordance with the direction of the arrow and with the distance from the arrow. The interest degree is calculated for each region-of-interest candidate, and the region of interest is specified from among the region-of-interest candidates based on the interest degree. Thus, the correct answer data indicating the region of interest can be easily created. Other

Here, the region-of-interest candidate disposing unit 38 disposes the plurality of region-of-interest candidates, and the region-of-interest specifying unit 42 specifies any region-of-interest candidate among the plurality of region-of-interest candidates as the region of interest. Instead, the region-of-interest candidate disposing unit 38 may dispose one region-of-interest candidate. In a case where, for example, the arrow indicates an end of the image, it may not be possible to dispose the plurality of region-of-interest candidates. In a case where there is one region-of-interest candidate, the region-of-interest specifying unit 42 is not necessarily required to specify the region-of-interest candidate as the region of interest. For example, in a case where the interest degree of the region-of-interest candidate is lower than a threshold value, the region-of-interest specifying unit 42 may determine that the region-of-interest candidate does not correspond to the region of interest.

In addition, even in a case where the plurality of region-of-interest candidates are disposed, the region-of-interest specifying unit 42 may determine that any of the region-of-interest candidates does not correspond to the region of interest in a case where the interest degree of any of the region-of-interest candidates is lower than the threshold value.

The medical image analysis apparatus, the medical image analysis method, and the medical image analysis program according to the present embodiment can also be applied to an image analysis apparatus, an image analysis method, and a program using a natural image other than the medical image. For example, the disclosed technology can be applied to a technology for acquiring an image that is an image of social infrastructure equipment such as transportation, electricity, gas, and water supply and in which the arrow is assigned to the region of interest, and for specifying the region of interest. Accordingly, since the region of interest of the image of the infrastructure equipment in which the arrow is assigned to the region of interest can be specified, the correct answer data indicating the region of interest can be easily created, and the learning model that estimates the region of interest from the image of the infrastructure equipment can be trained using the created correct answer data.

The technical scope of the present invention is not limited to the scope described in the embodiments. The configurations and the like in each embodiment can be appropriately combined between the embodiments without departing from the gist of the present invention.

### EXPLANATION OF REFERENCES

10: medical image analysis system
12: medical image examination apparatus
14: medical image database
16: user terminal apparatus
16A: input device
16B: display
18: reading report database
20: medical image analysis apparatus
20A: processor
20B: memory
20C: communication interface
22: network
32: image acquisition unit
34: arrow specifying unit
34A: arrow detection model
36: accessory information acquisition unit
38: region-of-interest candidate disposing unit
40: interest degree calculation unit
40A: interest degree calculation model
40B: image feature extraction model
42: region-of-interest specifying unit
44: output unit
A1: region of interest
A2: region of interest
AR1: arrow
AR2: arrow
AR3: arrow
AR4: arrow
AR11: arrow
AR12: arrow
AR13: arrow
AR21: arrow
AR31: arrow
AR32: arrow
C1: region-of-interest candidate
C2: region-of-interest candidate
C3: region-of-interest candidate
C11: region-of-interest candidate
C12: region-of-interest candidate
C13: region-of-interest candidate
C14: region-of-interest candidate
C21: region-of-interest candidate
C22: region-of-interest candidate
C23: region-of-interest candidate
C31: region-of-interest candidate
C41: region-of-interest candidate
C42: region-of-interest candidate
C43: region-of-interest candidate
C44: region-of-interest candidate
C51: region-of-interest candidate
C52: region-of-interest candidate
C53: region-of-interest candidate
C54: region-of-interest candidate
I1: medical image
I2: medical image
I3: medical image
R1: rectangle
R2: rectangle
R3: rectangle
R4: rectangle
S1 to S5, S11 to S16: step of medical image analysis method
S21 to S23: step of learning method of interest degree calculation model

What is claimed is:

1. An image analysis apparatus comprising:
at least one processor; and
at least one memory in which an instruction to be executed by the at least one processor is stored,
wherein the at least one processor is configured to:
receive an image in which an arrow is assigned to a region of interest;
specify the arrow;
dispose one or more region-of-interest candidates that are candidates of the region of interest in accordance with a direction of the arrow and with a distance from the arrow;
calculate an interest degree for each region-of-interest candidate; and
specify the region of interest from among the region-of-interest candidates based on the interest degree.

2. The image analysis apparatus according to claim 1,
wherein the region-of-interest candidate has a shape with which a size and a position of the region of interest is specifiable.

3. The image analysis apparatus according to claim 2,
wherein the region-of-interest candidate is a rectangle or a circle.

4. The image analysis apparatus according to claim 1,
wherein the at least one processor is configured to dispose the region-of-interest candidate in accordance with a first distance that is a first distance from a tip end of the arrow and that is in a normal direction of the direction of the arrow.

5. The image analysis apparatus according to claim 1,
wherein the at least one processor is configured to dispose the region-of-interest candidate in accordance with a second distance that is a second distance from a tip end of the arrow and that is in a direction parallel to the direction of the arrow.

6. The image analysis apparatus according to claim 1,
wherein the at least one processor is configured to:
acquire accessory information of the image; and
dispose the region-of-interest candidate in accordance with the accessory information.

7. The image analysis apparatus according to claim 6,
wherein the accessory information includes a sentence in which a content of the image is described.

8. The image analysis apparatus according to claim 6,
wherein the image is a medical image,
the region of interest is a lesion, and
the accessory information includes information about a size of the lesion.

9. The image analysis apparatus according to claim 1,
wherein the at least one processor is configured to calculate the interest degree for each region-of-interest candidate using a first interest degree calculation model that outputs the interest degree of the input region-of-interest candidate in a case where a feature of the image and the region of interest are input, or a second interest degree calculation model that outputs the interest degree of the input region-of-interest candidate in a case where the image and the region-of-interest candidate are input.

10. The image analysis apparatus according to claim 9,
wherein the first interest degree calculation model and the second interest degree calculation model are trained models that are trained by disposing a plurality of regions in an image having a known region of interest and by using an interest degree between the disposed region and the known region of interest as correct answer data.

11. The image analysis apparatus according to claim 1
wherein the at least one processor is configured to:
dispose a plurality of the region-of-interest candidates; and
specify the region-of-interest candidate having a highest interest degree among the plurality of region-of-interest candidates as the region of interest.

12. An image analysis method comprising:
receiving an image in which an arrow is assigned to a region of interest;
specifying the arrow;
disposing one or more region-of-interest candidates that are candidates of the region of interest in accordance with a direction of the arrow and with a distance from the arrow;
calculating an interest degree for each region-of-interest candidate; and
specifying the region of interest from among the region-of-interest candidates based on the interest degree.

13. A non-transitory, computer-readable tangible recording medium which records thereon a program for causing, when read by a computer, the computer to execute the image analysis method according to claim 12.
